(19) United States
(12) Patent Application Publication
(10) Pub. No.: US 2005/0108932 A1
(43) Pub. Date: May 26, 2005

(54) Components for ground covers for trees and bushes

(76) Inventor: Chih-Yu Hsia, Arcadia, CA (US)

Correspondence Address: Chih-Yu Hsia, 301 Warren Way, Arcadia, CA, 91007, US

(21) Appl. No.: 10/705,345

(22) Filed: Nov. 8, 2003

(51) Int. Cl. A01G 13/02

(52) U.S. Cl. 47/32

(57) ABSTRACT

A component for ground covers for trees and bushes consisting of a substantially non-transparent plate which at each rim has a rim strip which is a substantially non-transparent strip protruding from each rim of the substantially non-transparent plate which has many penetrable holes which allow pins to penetrate through and pin down the component on the ground; the substantially non-transparent plate having one or more weakened zone(s) which span(s) inclusively from one rim strip to the other rim strip; a portion of the substantially non-transparent plate being severable along the weakened zone; along an edge of each weakened zone the substantially non-transparent plate having a weakened zone strip which is a substantially non-transparent strip protruding from the surface of the substantially non-transparent plate; the weakened zone having at least a groove or the weakened zone being a curve depicted by a series of holes on the component; the substantially non-transparent plate having optionally a slightly concave top surface; the substantially non-transparent plate optionally having many small holes for air and water to penetrate through.

### BACKGROUND OF THE INVENTION

1. Field of the Invention

This invention relates to components for ground covers and particularly to components for ground covers for trees or bushes to control the growths of weeds around their trunks.

2. Descriptions of the Prior Arts

No prior art related to components for ground covers for trees and bushes was found.

### SUMMARY OF THE INVENTION

Weeds which growing around the trunks of trees or bushes not only create nuisances but also sometimes threaten or endanger the growths or health of the trees or bushes. Traditionally people uses weed whackers, mulches or pulling to control the growths of weeds around the trunks of trees or bushes. Using weed whackers to control weeds is not only time consuming but also risky in damaging the trunks of trees or bushes. Mulches used sometimes become the media for the growths of insects and diseases for the trees and bushes. Pulling the weeds is time and labor consuming. Therefore, a better and easier way to prevent the growths of weeds around the trunks or bushes is sought.

Weeds need light to live and grow. Therefore, a device to control the supply of light to the weeds to control the growths of weeds is invented. Components for ground covers that can be pinned down around the trunks of trees or bushes to cut-off the lights to weeds are invented. The invented components not only can be used to create a ground cover in various shapes and sizes around a trunk of a tree or a bush but also can reduce the dwellings of bugs and insects around the trunk. The invented components can also allow air and water to reach the roots around the trunk.

These and other objects and advantages of the invention, as well as the details of illustrative embodiments, will be more fully understood from the following specification and drawings, in which:

### DRAWING DESCRIPTION

FIG. 1 is an isometric view of the invented device.

FIG. 2 is a sectional view of the device shown in FIG. 1.

FIG. 3 is an isometric view that illustrates the use of the invented device shown in FIG. 1.

FIG. 4 is a sectional view that illustrates the use of the invented device shown in FIG. 1.

FIG. 5 is an isometric view of a variation of the invented device.

FIG. 6 is a sectional view of using the devices shown in FIG. 5.

FIG. 7 is an isometric view of the other variation of the invented device.

FIG. 8 is a sectional view of the device shown in FIG. 7.

FIGS. 9 and 10 are an isometric view of the variations of the invented device.

FIG. 11 is an isometric view that illustrates the use of the invented device shown in FIG. 9. Note that a portion of the invented device is severed to accommodate a relatively large trunk.

FIG. 12 is a sectional view of the device shown in FIG. 11.

### GENERAL DESCRIPTION

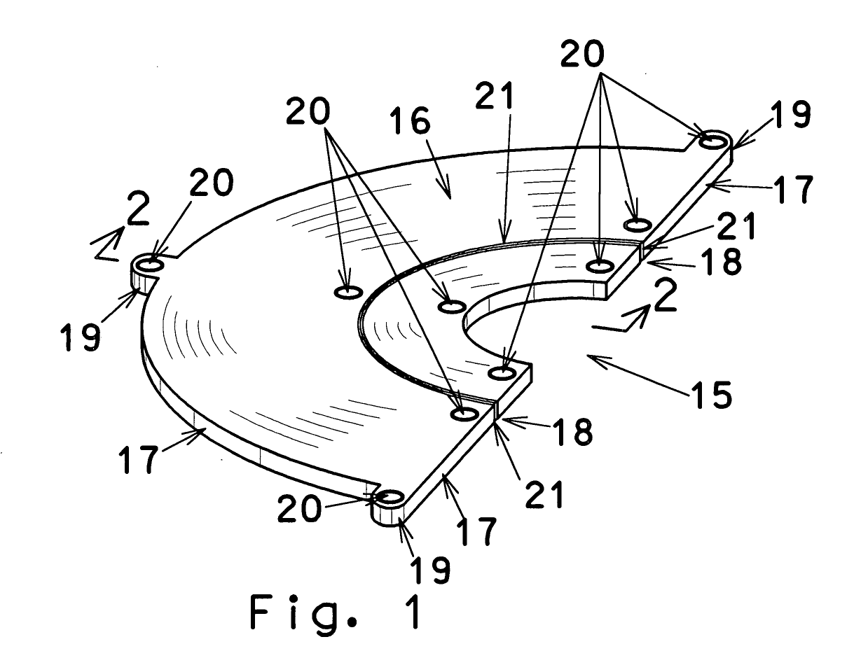

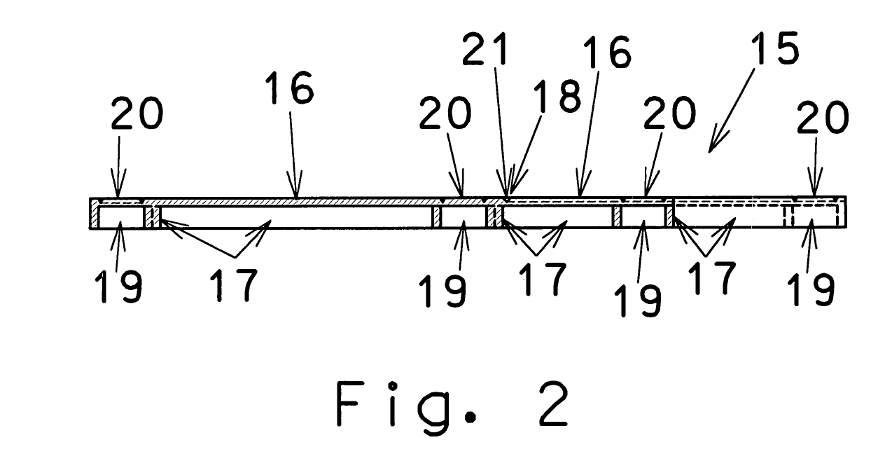

Referring to FIGS. 1 and 2, the invented component for ground covers for trees and bushes 15 consists of a substantially non-transparent plate 16 which has rim strips 17, many weakened zones 18 (only one shown in order not to cloud the drawings), and many penetrable areas 19. The substantially non-transparent plate is made of any suitable material that hampers the lights to penetrate through. The rim strip is a substantially non-transparent strip protruding from each rim of the substantially non-transparent plate in an about right angle to the top surface of the substantially non-transparent plate. The penetrable areas basically are short tubes with severable or penetrable covers 20. The penetrable area can allow a substantially pin-liked object to penetrate through to pin the invented device on the ground. The tube wall of a penetrable area will not allow lights to enter beneath the substantially non-transparent plate even if the severable or penetrable cover of the penetrable area is broken. The weakened zone is a groove 21 on the substantially non-transparent plate and the rim strip. The weakened zone spans inclusively from one rim strip to the other rim strip. A portion of the substantially non-transparent plate is severable along the weakened zone. Along an edge of each weakened zone the substantially non-transparent plate has a weakened zone strip 22 which is a substantially non-transparent strip protruding in an about right angle from the surface of the substantially non-transparent plate.

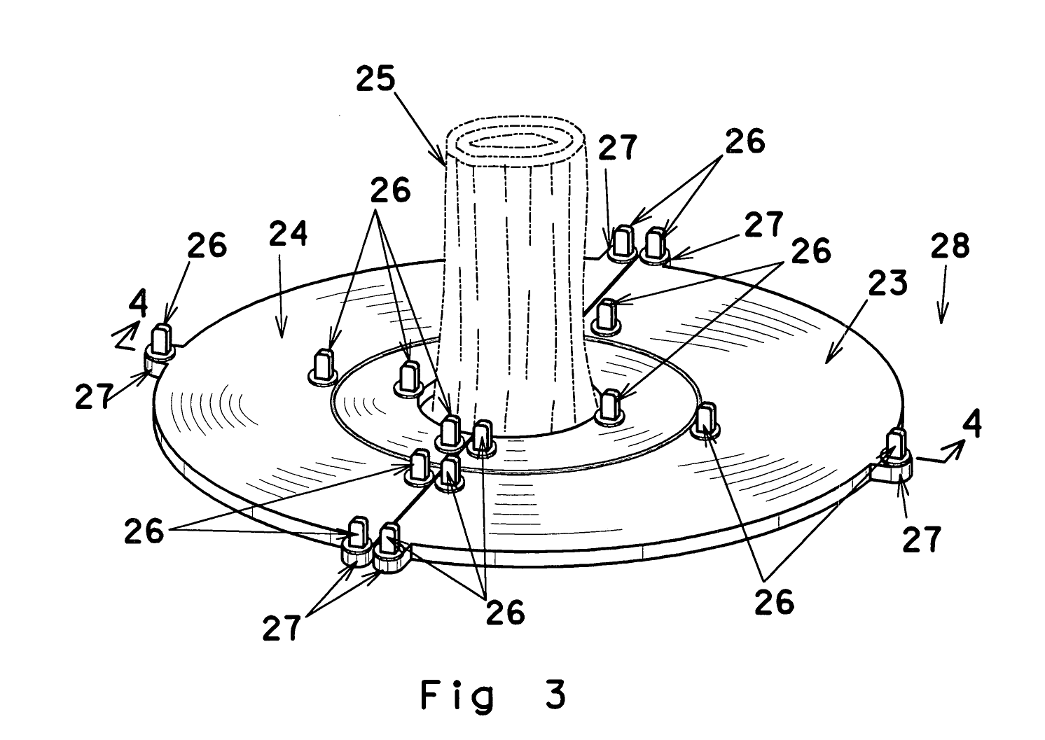

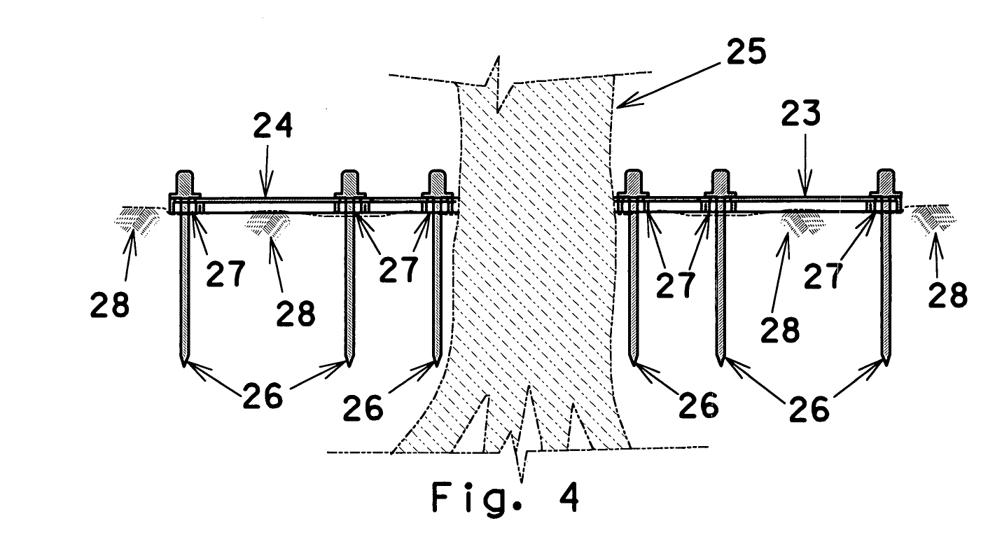

In using the invented devices, a user puts adequate amounts of invented components together to form a ground cover around a trunk of a tree. In doing so the user may have to tear away a portion or portions of the substantially non-transparent plates along the weakened zones to make spaces for the trunk to penetrate through the ground cover. Then the user pins the components down on ground with pins. For an example, referring to FIGS. 3 and 4, two invented components 23 and 24 are put around a trunk 25 of a tree. Then the user uses pins 26s that penetrate the penetrable areas 27s to pin the devices on the ground 28. Because the invented devices are substantially non-transparent, not enough lights can reach below them. Therefore, weeds can not grow underneath of the devices. Furthermore, because the tips of the rim strips will be partially into the ground and will create relatively tight seals to prevent insects or bugs from entering under the devices, the devices will not cause bug or insect problems for the tree.

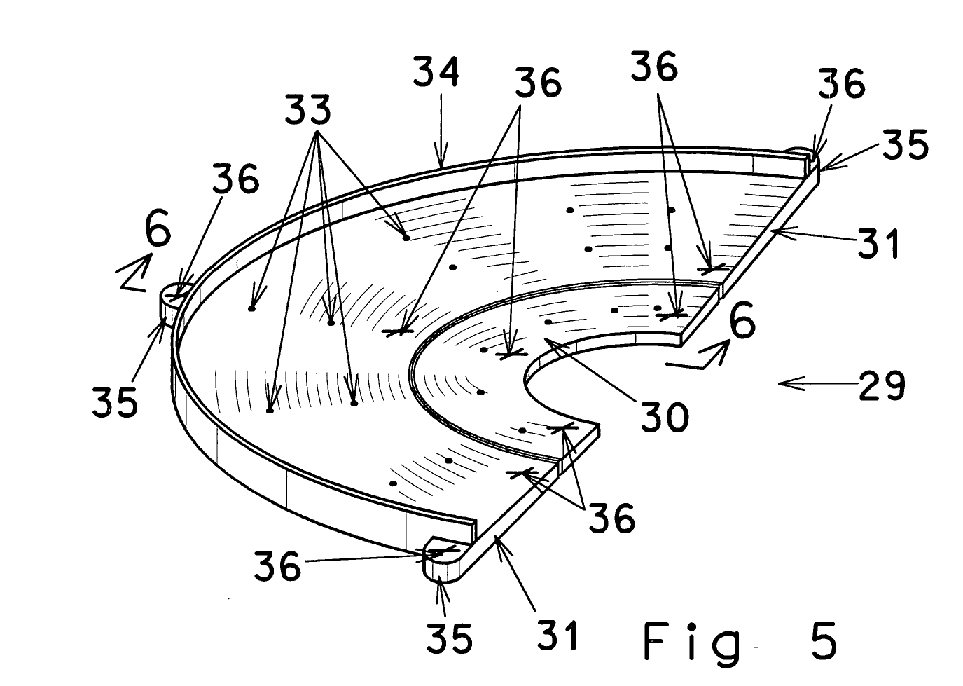

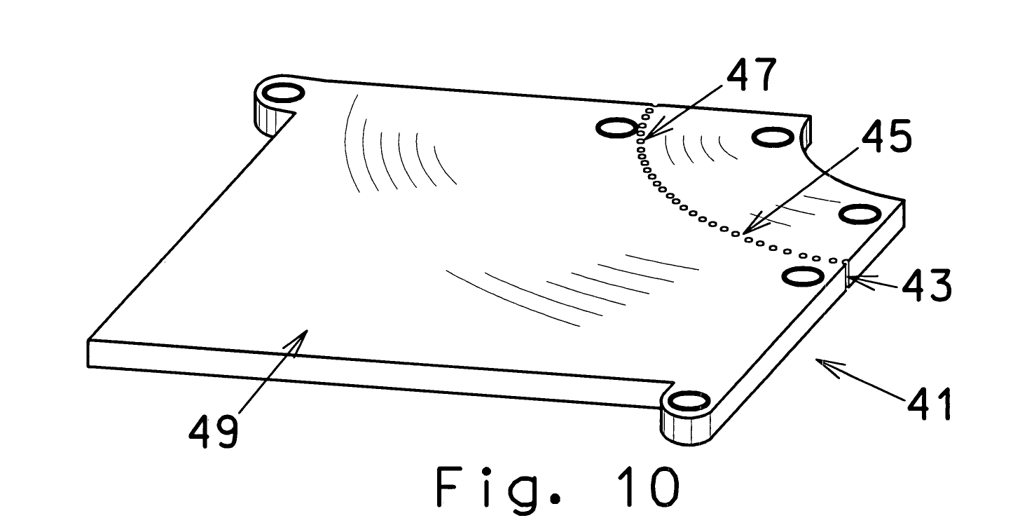

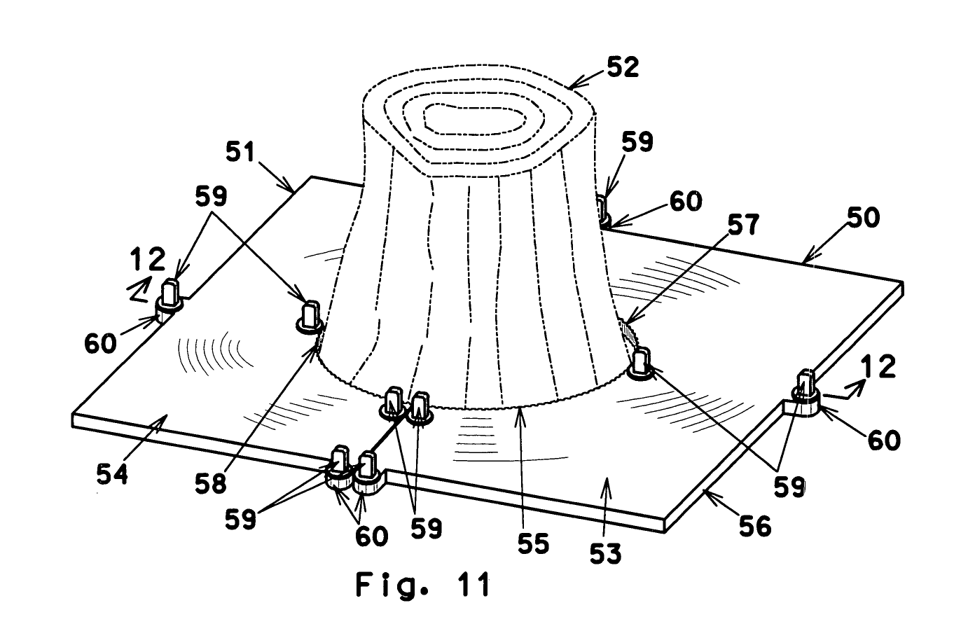

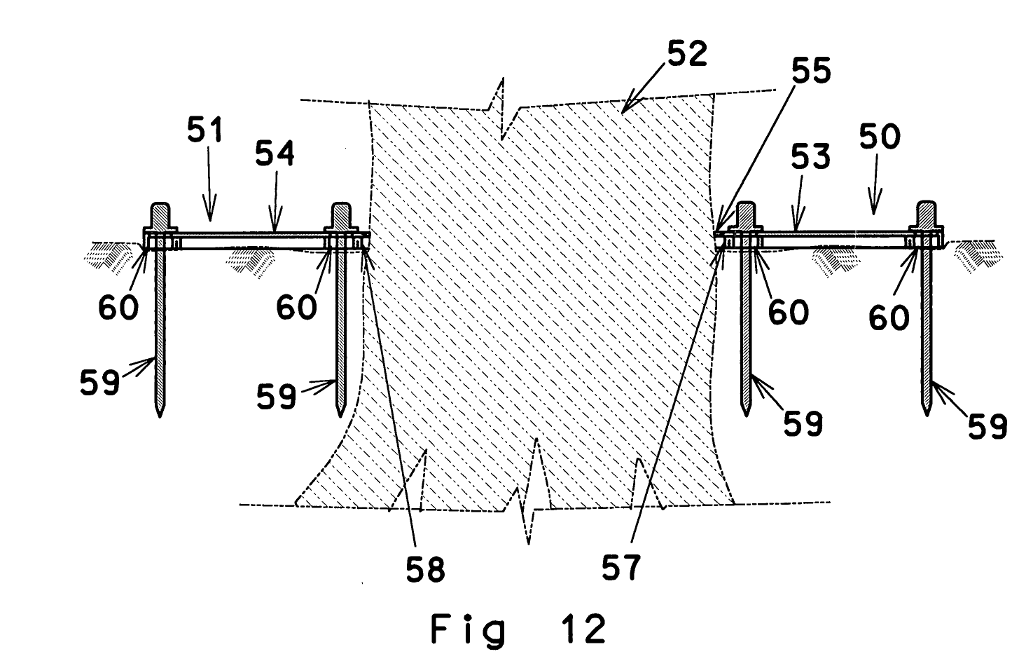

Many variations of the components can be readily derived from the invented devices. FIGS. 5 to 10 show some of them. FIGS. 11 and 12 illustrate the uses of some of them.

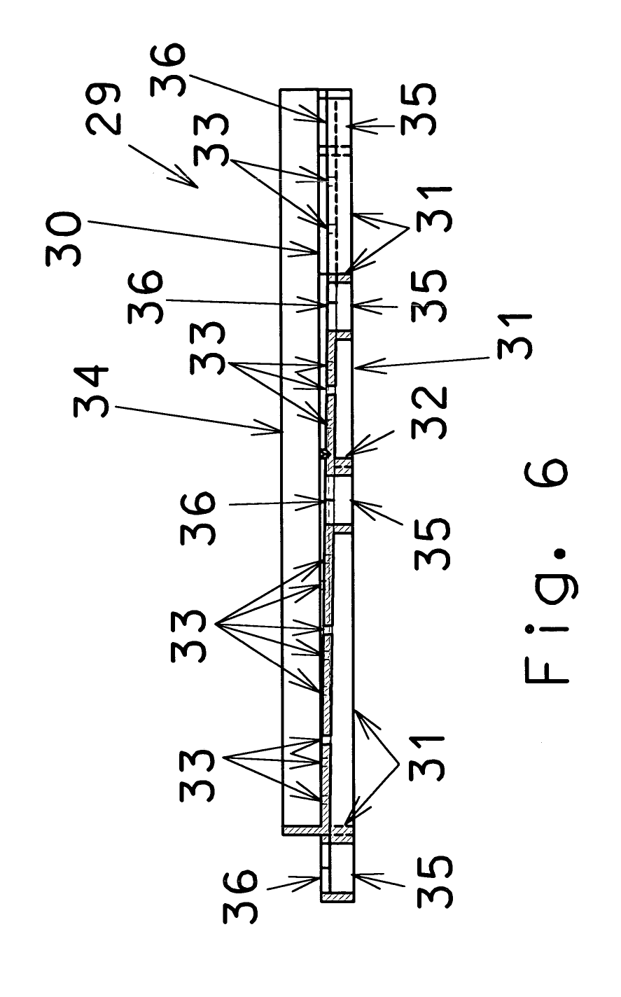

Referring to FIGS. 5 and 6, a variation of invented device 29 has a substantially non-transparent plate that has concave surface 30. The concave surface is formed by the uses of the non-uniform depths of some of the rim strips 31s and the weakened zone strips 32 (only one weakened zone is shown in order not to cloud the figures). The substantially non-transparent plate optionally has many small holes 33 which allows water and air to enter the spaces below the substantially non-transparent plate but limited amount of lights for sustaining lives of weeds below. The rim strip 34 along the outer rim (the rim that will not butt against another invented component) may optionally protrude from both sides of the surfaces of the substantially non-transparent plate. Because the rim strip 34 protrudes above the top surface of the substantially non-transparent plate, the rim strip 34 will prevent water poured on the top of the ground cover from spilling out. Thus, this increases the efficiencies of the irrigated water for the trees or bushes. The 35s and 36s are penetrable areas and penetrable covers, respectively. The rim strips, the weakened zone strips, the penetrable areas, and the penetrable covers, etc. are similar to those described for FIGS. 1 and 2.

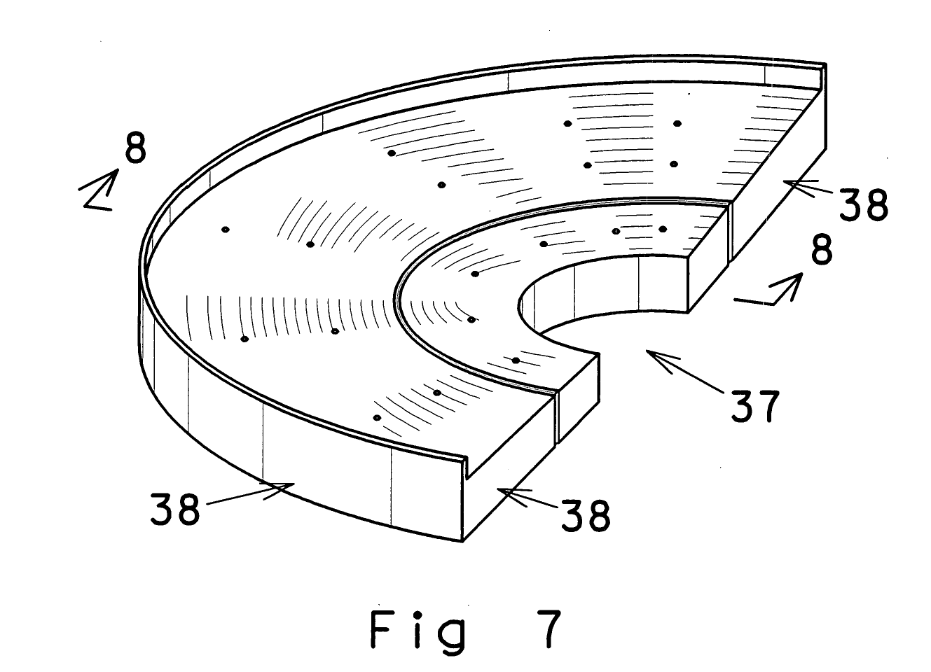

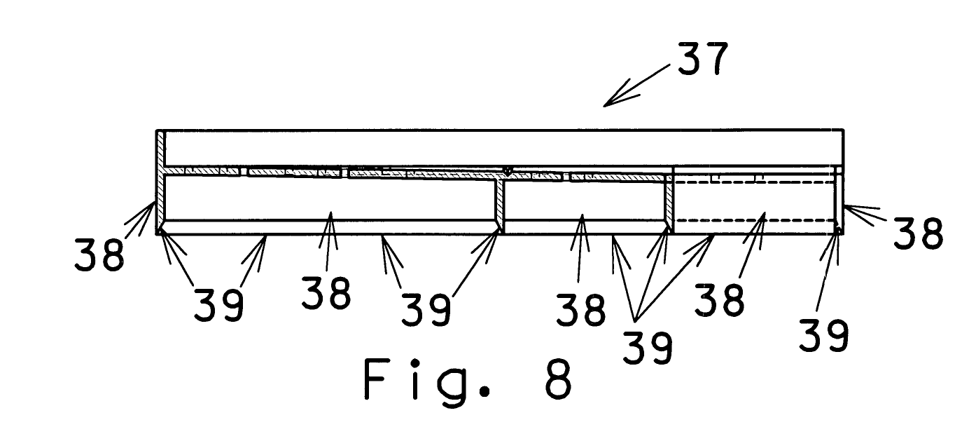

Referring to FIGS. 7 and 8, the invented component 37 can have relatively tall rim strips 38s that have sharp edges 39s at their bottom rims to facilitate their anchorage on the ground.

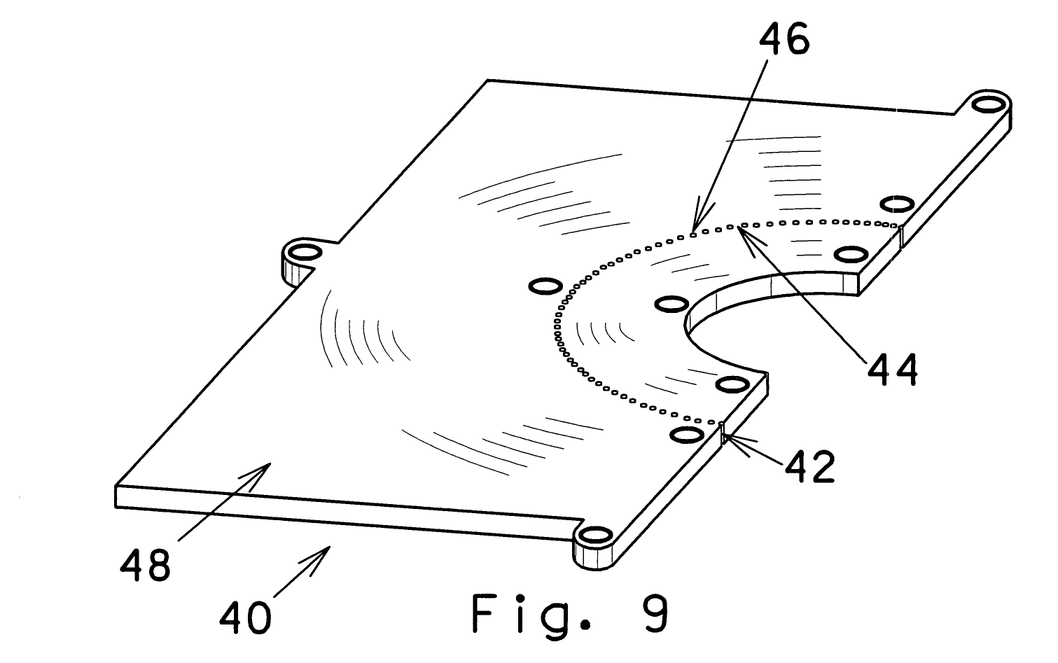

Referring to FIGS. 1, 5, 7, 9, and 10, the footprint shapes of the invented components can be sectors, rectangular or squares. The component 40 of FIG. 9 and the component 41 of FIG. 41 have rectangular footprints. Their weakened zones 42 and 43, are curves 44 and 45 depicted by series of holes or depressed areas 46 and 47 on the substantially non-transparent plates 48 and 49, all respectively.

As discussed earlier, the function of a weakened zone is to provide an area along which the substantially non-transparent plate can be severed easily. The purpose of having this function is to allow the invented components to be used for large trunks. FIGS. 11 and 12 illustrates this usage.

Referring to FIGS. 11 and 12, when the invented components 50 and 51 are used for a large trunk 52, the user severs the substantially non-transparent plates 53 and 54, respectively, along the weakened zones (not shown) and removes the non-needed severed substantially non-transparent plates. The purposes of doing these are to make an enlarged hole 55 for the large trunk 52 so that the ground cover 56 will not hamper the growth of the trunk. After the severance, the remaining weakened zone strips 57 and 58 will serve as barriers to prevent lights to enter underneath the substantially non-transparent plates 53 and 54. The user then uses the pins 59s to penetrate through the penetrable areas 60 to pin the components on ground. A ground cover around the trunk 52 is thus built.

The foregoing is considered as illustrative only of the principles of the invention. Furthermore, since numerous modifications and changes will readily occur to those skilled in the art, it is not desired to limit the invention to the exact construction and operation shown and described, and accordingly all suitable modifications and equivalents, may be resorted to, falling within the scope of the invention as claimed.

1. A component for ground covers for trees and bushes consisting of
a) a substantially non-transparent plate;
b) said substantially non-transparent plate having a rim strip at each rim;
c) said rim strip being a substantially non-transparent strip protruding from said each rim of said substantially non-transparent plate in an about right angle to the top surface of said substantially non-transparent plate;
d) said substantially non-transparent plate having a penetrable area in plural form;
e) said penetrable area being a short tube with a breakable cover;
f) said breakable cover being able to allow a substantially pin-liked object to break and penetrate through;
g) said substantially non-transparent plate having a weakened zone in plural form;
h) said weakened zone spanning inclusively from one said rim strip of said substantially non-transparent plate to the other said rim strip of said substantially non-transparent plate;
i) a portion of said substantially non-transparent plate being severable along said weakened zone;
j) along an edge of each said weakened zone said substantially non-transparent plate having a weakened zone strip which is a substantially non-transparent strip protruding in an about right angle from the surface of said substantially non-transparent plate.

2. A component for ground covers for trees and bushes of claim 1 wherein said breakable cover being a diaphragm of said short tube of said penetrable area.

3. A component for ground covers for trees and bushes of claim 1 wherein said weakened zone strip having a sharp edge.

4. A component for ground covers for trees and bushes of claim 1 wherein said rim strip having a sharp edge.

5. A component for ground covers for trees and bushes of claim 1 wherein said rim strip which will not butt against other said component protruding on both sides of the surfaces of said substantially non-transparent plate.

6. [symbol] 1 wherein sai m 15V

7. A component for ground covers for trees and bushes of claim 1 wherein said weakened zone being a curve depicted by a series of holes on said component.

8. A component for ground covers for trees and bushes of claim 1 wherein said weakened zone being a curve depicted by a series of depressed areas on said component.

9. A component for ground covers for trees and bushes of claim 1 wherein said substantially non-transparent plate having a slightly concave top surface.

10. A component for ground covers for trees and bushes of claim 1 wherein said substantially non-transparent plate having a hole in plural form for air and water to penetrate through.

11. A component for ground covers for trees and bushes consisting of
a) a substantially non-transparent plate;
b) said substantially non-transparent plate having a rim strip at each rim;
c) said rim strip being a substantially non-transparent strip protruding from said each rim of said substantially non-transparent plate in an about right angle to the top surface of said substantially non-transparent plate;
d) said substantially non-transparent plate having a penetrable area in plural form;
e) said penetrable area being a short tube with a breakable cover;
f) said breakable cover being able to allow a substantially pin-liked object to break and penetrate through;
g) said substantially non-transparent plate having a weakened zone;
h) said weakened zone spanning inclusively from one said rim strip of said substantially non-transparent plate to the other said rim strip of said substantially non-transparent plate;
i) a portion of said substantially non-transparent plate being severable along said weakened zone;
j) along an edge of said weakened zone said substantially non-transparent plate having a weakened zone strip which is a substantially non-transparent strip protruding in an about right angle from the surface of said substantially non-transparent plate.

12. A component for ground covers for trees and bushes of claim 11 wherein said breakable cover being a diaphragm of said short tube of said penetrable area.

13. A component for ground covers for trees and bushes of claim 11 wherein said weakened zone strip having a sharp edge.

14. A component for ground covers for trees and bushes of claim 11 wherein said rim strip having a sharp edge.

15. A component for ground covers for trees and bushes of claim 11 wherein said rim strip which will not butt against other said component protruding on both sides of the surfaces of said substantially non-transparent plate.

16. A component for ground covers for trees and bushes of claim 11 wherein said weakened zone having at least a groove on said component.

17. A component for ground covers for trees and bushes of claim 11 wherein said weakened zone being a curve depicted by a series of holes on said component.

18. A component for ground covers for trees and bushes of claim 11 wherein said weakened zone being a curve depicted by a series of depressed areas on said component.

19. A component for ground covers for trees and bushes of claim 11 wherein said substantially non-transparent plate having a slightly concave top surface.

20. A component for ground covers for trees and bushes of claim 11 wherein said substantially non-transparent plate having a hole in plural form for air and water to penetrate through.

21. A component for ground covers for trees and bushes consisting of
a) a substantially non-transparent plate;
b) said substantially non-transparent plate having a rim strip at each rim;
c) said rim strip being a substantially non-transparent strip protruding from said each rim of said substantially non-transparent plate in an about right angle to the top surface of said substantially non-transparent plate;
d) said substantially non-transparent plate having a penetrable area in plural form;
k) said penetrable area being a short tube with a breakable cover;
l) said breakable cover being able to allow a substantially pin-liked object to break and penetrate through.

22. A component for ground covers for trees and bushes of claim 21 wherein said breakable cover being a diaphragm of said short tube of said penetrable area.

23. A component for ground covers for trees and bushes of claim 21 wherein said rim strip having a sharp edge.

24. A component for ground covers for trees and bushes of claim 21 wherein said rim strip which will not butt against other said component protruding on both sides of the surfaces of said substantially non-transparent plate.

25. A component for ground covers for trees and bushes of claim 21 wherein said substantially non-transparent plate having a slightly concave top surface.

26. A component for ground covers for trees and bushes of claim 21 wherein said substantially non-transparent plate having a hole in plural form for air and water to penetrate through.
